(19) United States
(12) Patent Application Publication
(10) Pub. No.: US 2024/0299883 A1
(43) Pub. Date: Sep. 12, 2024

(54) COMPLEMENTARY METAL-OXIDE-SEMICONDUCTOR-BASED NANOFILTERS FOR DIAGNOSTICS

(71) Applicant: INTERNATIONAL BUSINESS MACHINES CORPORATION, ARMONK, NY (US)

(72) Inventors: Sagarika Mukesh, Albany, NY (US); Alexander Reznicek, Troy, NY (US); Sufi Zafar, Briarcliff Manor, NY (US); Bahman Hekmatshoartabari, White Plains, NY (US)

(21) Appl. No.: 18/178,622

(22) Filed: Mar. 6, 2023

(51) Int. Cl. B01D 61/02; B01D 37/00; B01D 67/00; B01D 71/02; B01L 3/00

(52) U.S. Cl. CPC B01D 61/027; B01D 37/00; B01D 67/0062; B01D 71/0213; B01D 71/024; B01L 3/502753; B01L 2200/0652; B01L 2200/12; B01L 2300/0645; B01L 2300/0681

(57) ABSTRACT

A structure that includes a substrate and a nanofilter formed on the substrate, wherein the nanofilter is adapted to allow nanoparticles of a predetermined size to pass through the nanofilter.

### BACKGROUND

The present disclosure relates to a filter for particles. More particularly, the present disclosure provides a complementary metal-oxide-semiconductor-based nanofilter for diagnostic purposes.

The medical diagnostics industry is a vital element of today's health care infrastructure. Devices of systems that can improve medical diagnoses are desired. Particle separation and filtration has been used for technological solutions in medicine, such as in medical diagnostics.

### SUMMARY

According to some embodiments of the disclosure, there is provided a structure. The structure includes a substrate and a nanofilter formed on the substrate, wherein the nanofilter is adapted to allow nanoparticles of a predetermined size to pass through the nanofilter.

According to some embodiments of the disclosure, there is provided a system comprising a nanofilter structure and a collection chamber. The nanofilter structure includes a substrate and a nanofilter formed on the substrate, wherein the nanofilter is adapted to allow nanoparticles of a predetermined size to pass through the nanofilter. The collection chamber is adapted to collect the nanoparticles of the predetermined size that pass through the nanofilter and including a plurality of devices adapted to detect a presence of the nanoparticles in the collection chamber.

According to some embodiments of the disclosure, there is provided a method of using a nanofilter system. The method includes an operation of providing the nanofilter system. The nanofilter system includes a nanofilter structure and a collection chamber. The nanofilter structure includes a substrate and a nanofilter formed on the substrate, wherein the nanofilter is adapted to allow nanoparticles of a predetermined size to pass through the nanofilter. The collection chamber is adapted to collect the nanoparticles of the predetermined size that pass through the nanofilter and including a plurality of devices adapted to detect a presence of the nanoparticles in the collection chamber. The method also includes an operation of injecting a sample including the nanoparticles into the nanofilter structure. The method further includes an operation of filtering the nanoparticles larger than the predetermined size out of the sample by the nanofilter. The method additionally includes operations of collecting a filtrate including the nanoparticles of the predetermined size from the nanofilter in the collection chamber, and detecting the presence of the nanoparticles of the predetermined size in the collection chamber.

According to some embodiments of the disclosure, there is provided a method of making a nanofilter structure. The method includes an operation of providing a substrate. The method also includes an operation of depositing a stack of alternating oxide layers and nitride layers on the substrate, wherein the nitride layers have a predetermined thickness. The method further includes an operation of etching the stack to form slices of the stack of the oxide layers and the nitride layers. The method additionally includes an operation of depositing an amorphous silicon layer on top of and surrounding the slices. The method also includes an operation of etching the amorphous silicon layer to form walls between and surrounding the slices. The method further includes an operation of selectively etching away the nitride layers from the slices.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a perspective view of a nanofilter structure, in accordance with embodiments of the present disclosure.

FIG. 2 is a perspective view of the nanofilter structure of FIG. 1 from a different angle, in accordance with embodiments of the present disclosure.

FIG. 3 is a top-down view of a nanofilter portion of the nanofilter structure of FIG. 1, in accordance with embodiments of the present disclosure.

FIG. 4 is a cross-sectional view of a nanofilter structure at an early fabrication operation in successive fabrication operations of a process of forming the nanofilter structure, in accordance with embodiments of the present disclosure.

FIG. 5 is a cross-sectional view illustrating a process operation following that of FIG. 4, in accordance with embodiments of the present disclosure.

FIG. 6 is a cross-sectional view illustrating a process operation following that of FIG. 5, in accordance with embodiments of the present disclosure.

FIG. 7 is a cross-sectional view illustrating a process operation following that of FIG. 6, in accordance with embodiments of the present disclosure.

FIG. 8 is a cut-away, perspective view illustrating a process operation following that of FIG. 7, in accordance with embodiments of the present disclosure.

FIG. 9 is a cross-sectional view illustrating a process operation following that of FIG. 8, in accordance with embodiments of the present disclosure.

FIG. 10 is a cross-sectional view illustrating a process operation following that of FIG. 9, in accordance with embodiments of the present disclosure.

FIG. 11 is a cross-sectional view illustrating a process operation following that of FIG. 10, in accordance with embodiments of the present disclosure.

FIG. 12 is a schematic view of an operational flow of a diagnostic system utilizing the nanofilter structure of FIG. 1, in accordance with embodiments of the present disclosure.

FIG. 13 is a schematic view of an operational flow of a diagnostic system utilizing a plurality of nanofilter structures of FIG. 1, in accordance with embodiments of the present disclosure.

FIG. 14 is a flowchart showing a process for making the nanofilter structure of FIG. 1, in accordance with embodiments of the present disclosure.

FIG. 15 is a flowchart showing a process for using a nanofilter system, in accordance with embodiments of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to a filter for particles. More particularly, the present disclosure provides a complementary metal-oxide-semiconductor-based nanofilter for diagnostic purposes. While the present disclosure is not necessarily limited to such applications, various aspects of the disclosure can be appreciated through a discussion of various examples using this context.

There are known, advanced manufacturing techniques available in the field of semiconductors that can be used to manufacture transistors and interconnects. Such manufacturing techniques have been utilized to build precise, nano-scale filters. The precise nano-scale filters can be used in the field of medicine, for example. Improved techniques and systems in medical diagnostics in which precise detection of nano-scale particles are desired. A potential for identifying nano-scale-sized individual proteins, for example, could enable early and specific detection of conditions such as heart attack (i.e., myocardial infarction (MI)), liver disease, and many others. Current diagnostic applications can rely on accumulation of a certain level of particles before detection is possible. For example, a certain level of exosomes may need to accumulate before cancer detection is possible. Early detection of cancer could be possible if a diagnostic method can detect a low level of nano-sized particles, such as exosomes.

Filtration or separation of nano-sized particles can be necessary in medical treatment. For example, plasmapheresis is a process where blood is separated into red cells, white cells, platelets and plasma. Plasma is needed for several therapeutic applications and has a potential to provide tremendous advantage. However, plasma contains several nano-scale proteins that can cause cross-reactivity, which makes the process of blood transfusion involving plasma risky. Therefore, separation of such nano-scale proteins from the remainder of the plasma is desired.

Embodiments of the present disclosure include a complementary metal-oxide-semiconductor (CMOS) processing-based nanofilter that can be used for the filtration of nano-scale biological particles, for example. The nanofilter can be made using CMOS processes. A “nanofilter” is defined as a filter that removes nanoscale material. The nanofilter can be used to in medical diagnostics and treatment, for example, in order to identify and/or separate out nanoparticles from a sample.

Embodiments of the present disclosure utilize silicon fabrication technology, or nanotechnology, to create an integrated silicon-chip platform that can be used for nano-filtration for example, in medical diagnostics. Through such fabrication techniques, the integrated silicon-chip platform for nano-filtration, or “nanofilter,” can be customized to include channel sizes capable of filtering nanoparticles having particle sizes lower than one hundred (100) nm, and down to as low as ten (10) nm, based on a desired application. For example, sizes of openings in a nanofilter can be made to allow only certain nano-scale sizes of proteins or viruses through the nanofilter, in order to allow for identification of such proteins or viruses that may be attributed to certain diagnoses or medical conditions. The opening size can be particularly designed to allow one particular virus or protein having a particular size through the nanofilter. A channel width of the nanofilter can be determined or made through photolithography rather than by an expensive extreme ultraviolet (EUV) lithography process that is used in silicon fabrication techniques. The nanofilter can include nanoscale grating for filtering out particles larger than openings through the grating. The grating size can be determined through conformal film deposition. The nanofilter can be coated with enzymes, for example, in order to prevent non-specific binding of proteins or other filtrates to the channels or the nano-scale grating. The nanofilter can be used in a medical diagnostic system to filter a sample, allow for collection of certain sized nano-particles that pass through the nanofilter, and detect certain nanoparticles in the collection that indicate a medical condition.

One feature and advantage of the disclosed structures and processes is that filtration of nano-scale biological particles is enabled. The filtration of the nano-scale biological particles can lead to improved diagnostics and early and more specific detection of conditions such as MI, diabetes, high cholesterol, etc. Another advantage is that the structures are capable of being mass-produced using the disclosed manufacturing process, which can also reduce the cost of the structures. The disclosed processes utilize nanotechnology techniques to manufacture customizable nanofilters. However, the disclosed processes do not require relatively expensive materials or relatively expensive lithographic processes, for example, to create the nanofilters described herein.

For the sake of brevity, conventional techniques related to semiconductor device and integrated circuit (IC) fabrication may or may not be described in detail herein. Moreover, the various tasks and process steps or operations described herein can be incorporated into a more comprehensive procedure or process having additional operations or functionality not described in detail herein.

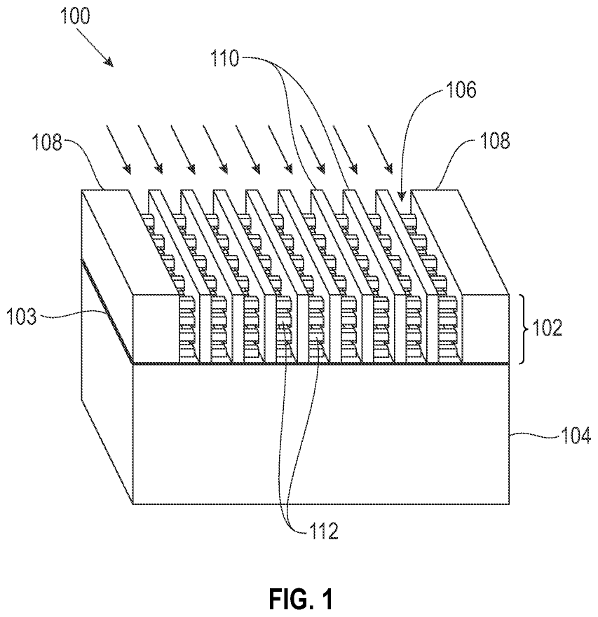

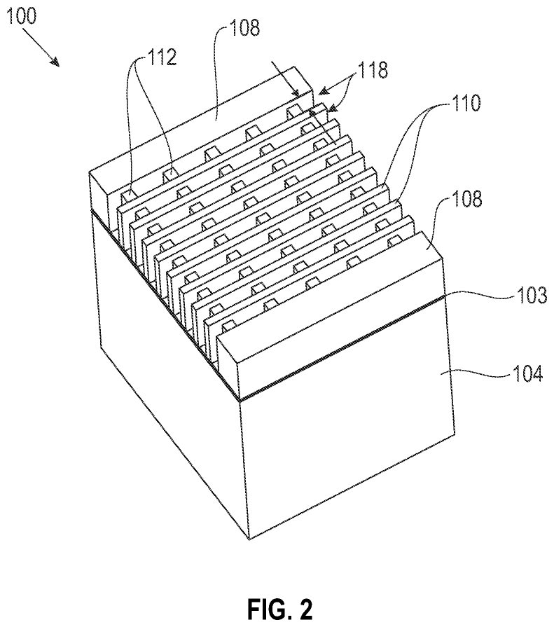

Turning to the figures, FIG. 1 is a perspective view of a nanofilter structure 100, in accordance with embodiments of the present disclosure. FIG. 2 is a perspective view of the nanofilter structure 100 of FIG. 1 from a different angle, in accordance with embodiments of the present disclosure. The nanofilter structure 100 includes a nanofilter portion 102 (i.e., nanofilter) located on top of a wafer 104. The wafer 104 in the nanofilter structure 100 described in the present disclosure can be made of silicon. However, it is contemplated that the wafer 104 can, alternatively, be a glass substrate, a plastic substrate or any other suitable substrate. If the wafer 104 is made of silicon, for example, a biocompatible material layer 103 can be deposited atop the wafer 104 and can be located between the nanofilter portion 102 and the wafer 104. A purpose of the biocompatible material layer 103 can be to prevent a sample being run through the nanofilter structure 100 from contacting the wafer 104. The biocompatible material making up the biocompatible material layer 103 can include, for example, enzymes, bovine serum albumin (BSA), polyethylene glycol (PEG), etc., which can be used to prevent non-specific binding. Other suitable biocompatible materials are contemplated for the biocompatible material layer 103. In some embodiments, the entire nanofilter structure 100 can be coated in a layer of such biocompatible material. A purpose of coating the nanofilter structure 100 is to prevent nanoparticles from sticking to portions of the nanofilter structure 100 and from clogging up the nanofilter structure 100.

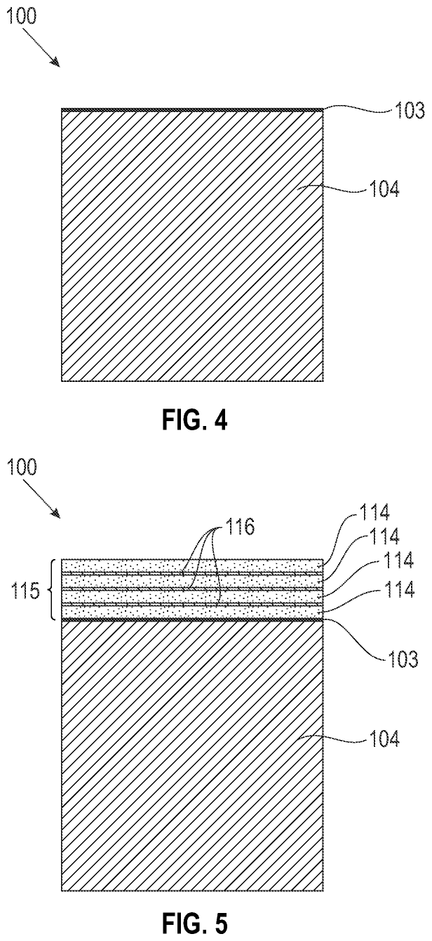

The nanofilter portion 102 includes a grating structure 106 located between two anchors 108. A plurality of walls 110 also are located between the two anchors 108. The grating structure 106 includes a plurality of grates 112 that are portions of oxide layers (114 in FIG. 5) that result from nitride layers (116 in FIG. 5) having been etched, etc. using manufacturing techniques described below with regard to FIGS. 4-11 to result in the grates 112. The walls 110 can be distributed in the nanofilter portion 102 in order to support the grates 112. A sample fluid moving through the nanofilter structure 100 could cause the grates 112 to deform if they are not sufficiently supported by the walls 110. When the density of the walls 110 can be determined, suspension of the portions of the oxide layers (114 in FIG. 5) between the walls 110 can be taken into consideration. In addition, the density (or number) of the walls 110 in the nanofilter structure 100 can be determined to ensure mechanical integrity of a plurality of channels 118 (FIG. 2) formed therebetween.

The arrows in FIG. 2 indicate a distance between two of the walls 110 that form one of the plurality of channels 118, and shows a width of one of the channels 118. The widths of the channels 118 can together define and accommodate a volume of a sample to be filtered. As described below, with regard to the manufacturing process (in FIGS. 4-11), the channels 118 can be defined by lithography. A range of possible widths of the channels 118 can be one hundred (100) nm to one (1) micrometer wide, for example. The arrows included in FIG. 1 show a direction that the sample can move into the nanofilter structure 100. The grating structure 106 is sized in order to filter out particles larger than a size of openings in the grating structure 106. Particles below the size of the openings in the grating structure 106 can pass through.

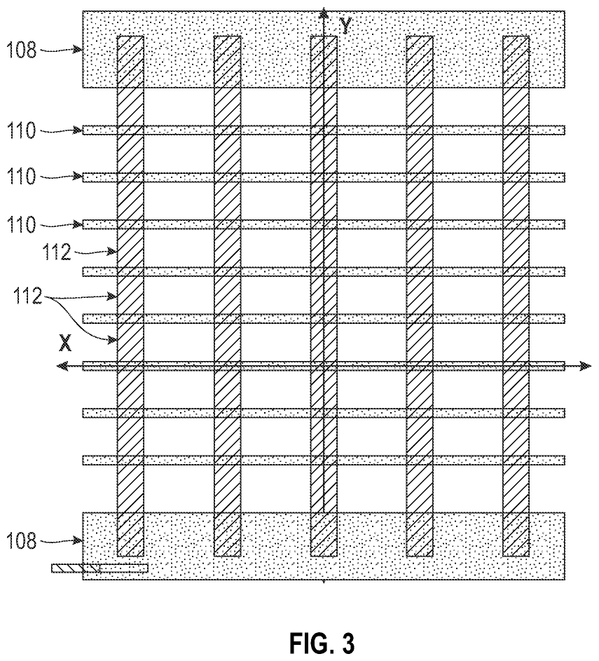

FIG. 3 is a top-down view of the nanofilter portion 102 of the nanofilter structure 100 of FIG. 1, in accordance with embodiments of the present disclosure. The figure shows the anchors 108 and the grates 112 extending between the anchors 108. In addition, the plurality of walls 110 are included in the figure. An X-axis and a Y-axis are indicated on the figure that will be referred to in a discussion that follows regarding a manufacturing flow of the nanofilter structure 100 shown in FIGS. 4-11.

FIGS. 4-11 are cross-sectional views of a manufacturing flow of the nanofilter structure 100, in accordance with embodiments of the present disclosure. FIG. 4 shows the nanofilter structure 100 at an early fabrication operation in successive fabrication operations of a process of forming the nanofilter structure 100. As shown in the figure, the wafer 104, or substrate, is provided. The wafer 104 can be made from a dielectric material, such as silicon. Building something biological directly on the wafer 104 may not be desired, so the biocompatible material layer 103 can be deposited atop the wafer 104. Processes that can be used to deposit the biocompatible material layer 103, or film, include, but are not limited to, self assembly. Self assembly is a common process for deposition, which can be done at a certain time based on a shelf-life of the biocompatible material layer 103.

FIG. 5 is a cross-sectional view illustrating a process operation following that of FIG. 4, in accordance with embodiments of the disclosure. The figure shows oxide layers 114 and nitride layers 116 deposited in an alternating fashion atop the biocompatible material layer 103 on the wafer 104. Deposition of the oxide layers 114 and the nitride layers 116 can be performed by chemical vapor deposition (CVD), physical vapor deposition (PVD), atomic layer deposition (ALD), and plasma enhanced CVD (PECVD), for example. A thickness of the nitride layers 116 can determine the size of the nanoparticles that can be filtered out by a final nanofilter structure 100 (as in FIG. 1). This thickness can be referred to as a “critical filter dimension.” An example of the critical filer dimension of the nanofilter structure 100 can be ten (10) to one hundred (100) nanometers (nm).

A stack 115 of the alternating oxide layers 114 and nitride layers 116, as shown in FIG. 5, can then be patterned and etched to define the nanofilter portion 102, such as the width of the channels 118, etc. A first photolithographic process, for example, can be used in order to pattern and etch the stack 115 of oxide layer 114 and nitride layers 116.

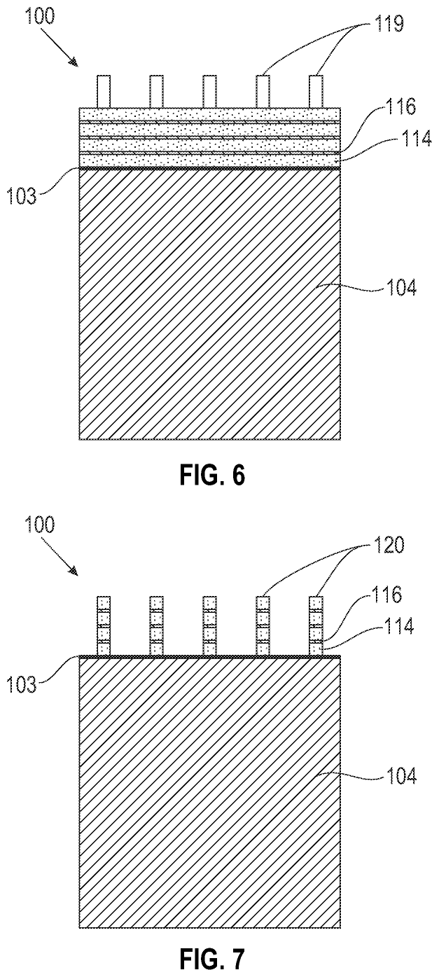

FIG. 6 is a cross-sectional view illustrating a process operation following that of FIG. 5, in accordance with embodiments of the disclosure. The figure is a cross-sectional view along axis Y (in FIG. 3) and includes portions of a first photoresist layer 119 atop the uppermost oxide layer 114 in the stack 115, which illustrates a step in the first photolithographic process.

FIG. 7 is a cross-sectional view illustrating a process operation following that of FIG. 6, and after etching was performed using the first photolithographic process, in accordance with embodiments of the disclosure. The figure is a cross-sectional view along axis X (in FIG. 3) and includes slices 120 of the stack 115 of oxide layers 114 and the nitride layers 116 that remain after the etching. The first photoresist layer 119 (in FIG. 6) has also been removed in the figure.

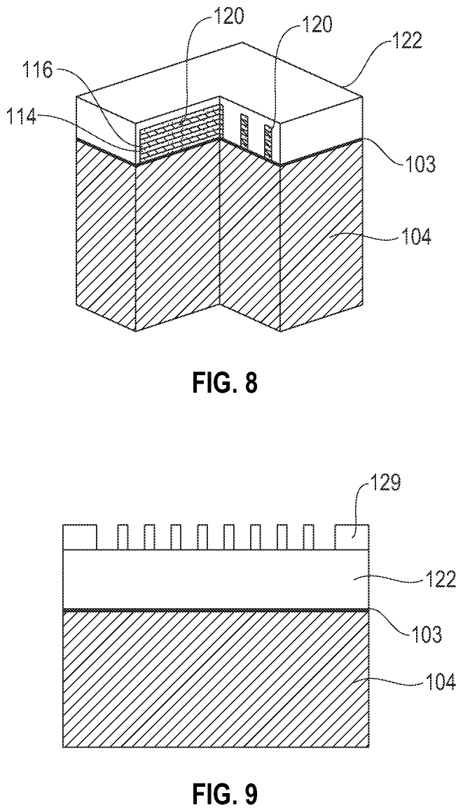

FIG. 8 is a cut-away, perspective view illustrating a process operation following that of FIG. 7, in accordance with embodiments of the disclosure. As shown, an amorphous silicon (aSi) layer 122 is deposited over and surrounding the slices 120 of the stack 115 of oxide layers 114 and the nitride layers 116, and is shown after chemical-mechanical polishing (CMP) was used to planarize the aSi layer 122. Deposition of the aSi layer 122 can be performed by CVD, PVD, ALD, and PECVD, for example. The aSi layer 122 can serve to anchor the slices 120 of the stack 115 of oxide layers 114 and the nitride layers 116.

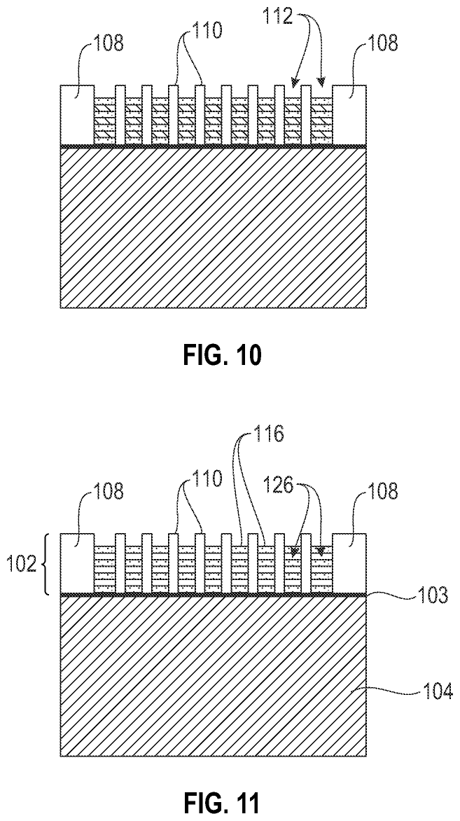

FIG. 9 is a cross-sectional view (through Y axis (in FIG. 3)) illustrating a process operation following that of FIG. 8, in accordance with embodiments of the disclosure. This shows the nanofilter structure 100 after patterning is performed using a second photolithographic process to eventually form the anchors 108 and the walls 110 (in FIG. 1). As shown, a second photoresist layer 129 is located on the aSi layer 122, and has been patterned as shown. The pattern shown can define the widths of the walls 110, the channels 118, and the anchors 108 (as in FIGS. 1-2).

FIG. 10 is a cross-sectional view (through Y axis (in FIG. 3)) illustrating a process operation following that of FIG. 10, in accordance with embodiments of the disclosure. The aSi layer 122 has been etched to define the channels 118 and anchors 108. The second photoresist layer 129 (in FIG. 9) is shown removed.

FIG. 11 is a cross-sectional view (through Y axis (in FIG. 3)) illustrating a process operation following that of FIG. 10, in accordance with embodiments of the disclosure. As shown, the nanofilter structure 100 has undergone a selective wet etch process after what is shown in FIG. 10. The wet etch process can include using, for example, mixtures of nitrogen fluoride (NF₃)/nitrogen (N₂)/oxygen (O₂)/hydrogen (H₂). This can be done for plasma etching silicon nitride (SiₓN_{y}) selective to silicon oxide (SiₓO_{y}). As a result of a selective wet etch of the remaining nitride layers 116, the grates 112, made of the oxide material (the remaining oxide layers 114) with grate openings 126 therebetween, are formed.

The process flow described above can be modulated in order to accommodate different sizes of nanoparticles. The grating size (or size of the openings 126) can be determined through conformal film deposition techniques, which can be quite precise (e.g., within one (1) nanometer (nm) precision).

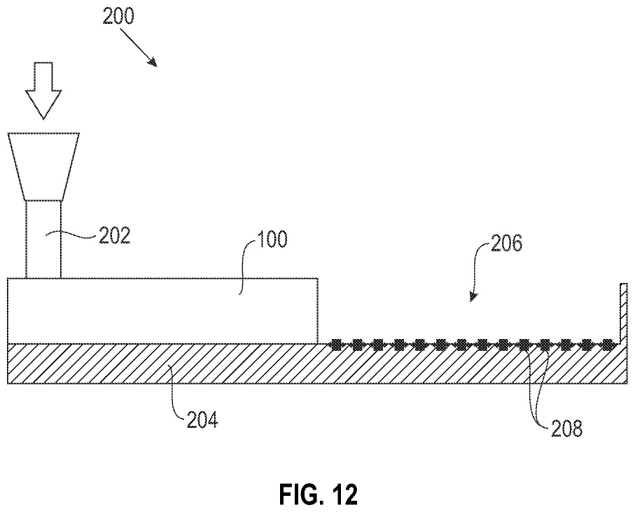

FIG. 12 is a schematic view of an operational flow of a diagnostic system 200 utilizing the nanofilter structure 100, in accordance with embodiments of the disclosure. The diagnostic system 200 can include a funnel delivery component 202 through which a sample of a body fluid, e.g., blood, saliva, plasma, urine, sweat, or other material, can be injected or introduced to one end of the nanofilter structure 100. The nanofilter structure 100 can be attached to a base 204, for example. The progression of the fluid through the nanofilter structure 100 can be pressure-based or charge/electric field-based, for example. Any filtrates that are smaller than a size of the grating openings 126 (as in FIG. 11) in the nanofilter structure 100 will proceed through the nanofilter structure 100 and exit a second end and move into a collection chamber 206 that can be also attached to or part of the base 204.

The collection chamber 206 can include a plurality of sensors 208, for example, that can detect or identify a certain nanoparticle or nanoparticles that may indicate a medical diagnosis, for example. The collection chamber 206 can include in-built or off-the-shelf bipolar junction transistors (BJTs) or another transistor-based device for detection of nanoparticles, for example. That nanoparticles can be identified by such transistors based on their electric signature. Other suitable devices and methods of identifying nanoparticles in the collection chamber 206, however, are also contemplated by the disclosure. Some examples of sensors 208 that can be used are described in U.S. Pat. Nos. 10,411,109, 10,892,346 and 10,900,952, which are incorporated herein by reference. Depending upon an application for the system 200, optical detection of nanoparticles can also be implemented.

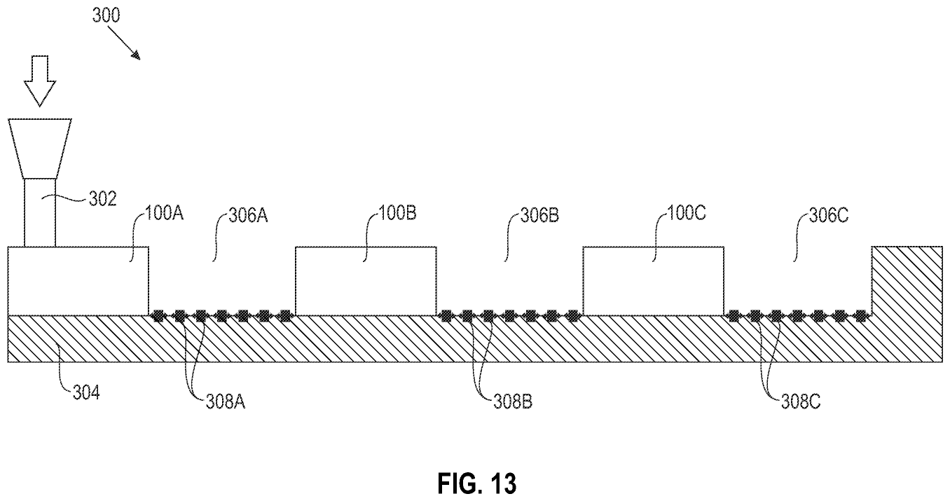

FIG. 13 is a schematic view of an operational flow of a diagnostic system 300 utilizing a plurality nanofilter structures 100A, 100B, 100C, in accordance with embodiments of the disclosure. The system 300 includes the plurality of nanofilter structures 100A, 100B, 100C, for example, that are “stacked” or used in a series to filter a sample a number of times for increasingly smaller nanoparticles, for example. The diagnostic system 300 can include a funnel component 302 through which a sample of a body fluid, e.g., blood, saliva, plasma, urine, sweat, or other material, can be injected or introduced to one end of a first nanofilter structure 100A. The first nanofilter structure 100A can be attached to a base 304, for example. The progression of the fluid through the first nanofilter structure 100A, and all of the other nanofilter structures shown (including 100B, 100C), can be pressure-based or charge/electric field-based, for example. Any nanoparticles that are smaller than a size of the grating openings (126 in FIG. 11) in the first nanofilter structure 100A will proceed through the first nanofilter structure 100A and exit a second end and move into a first collection chamber 306A of a series of collection chambers (including 306B, 306C) that can be also attached to or part of the base 304. The remaining sample filtered by the first nanofilter structure 100A and in the first collection chamber 306A can then be moved into the second nanofilter structure 100B, with filtrate collecting in the second collection chamber 306B. The sample in the second collection chamber 306B can then be moved through the third nanofilter structure 100C, with filtrate being collected in the third collection chamber 306C. The first, second and third nanofilters 100A, 100B, 100C can have increasingly smaller grating openings in order to filter out increasingly smaller nanoparticles. The system 300 can implement nanofilters of different critical dimensions (i.e., 100 nm, 75 nm, 40 nm, etc.) in series so as to progressively remove particles of decreasing sizes.

As in the system 200 in FIG. 12, the collection chambers 306A, 306B, 306C in system 300 can include a plurality of sensors 308A, 308B, 308C. The discussion above with regard to the sensors 208 in the system 200 in FIG. 12 also applies to the sensors 308A, 308B, 308C in the system 300 in FIG. 13.

The two diagnostic systems 200, 300 shown in FIGS. 12 and 13 are examples of systems into which the nanofilter structure 100 described herein can be incorporated. Other suitable systems are also contemplated by the present disclosure.

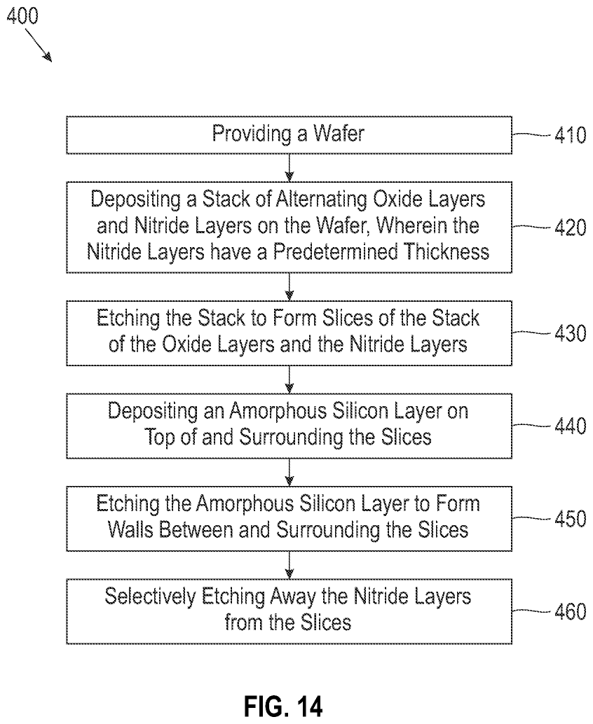

An embodiment of a disclosed process 400 for making the nanofilter structure 100 is shown in FIG. 14. An operation 410 in the process 400 can be providing a wafer 104, or substrate (in FIG. 4). Another operation 420 can be depositing a stack 115 of alternating oxide layers 114 and nitride layers 116 on the wafer 104, wherein the nitride layers 116 have a predetermined thickness. A further operation 430 can be etching the stack 115 to form slices 120 of the stack 115 of the oxide layers 114 and the nitride layers 116. Yet another operation 440 can be depositing an amorphous silicon layer 122 on top of and surrounding the slices 120. Another operation 450 can be etching the amorphous silicon layer 122 to form walls 110 between and surrounding the slices 120. Yet a further operation 460 can be selectively etching away the nitride layers 116 from the slices 120. The etching away of the nitride layers 116 of the predetermined thickness can result in openings 126 in the nanofilter portion 102 having a predetermined size that corresponds to a predetermined size of nanoparticle that is desired to move through the openings 126 in the nanofilter portion 102. Another operation, for example, can include depositing a biocompatible material layer 103 between the wafer 104 and the stack 115.

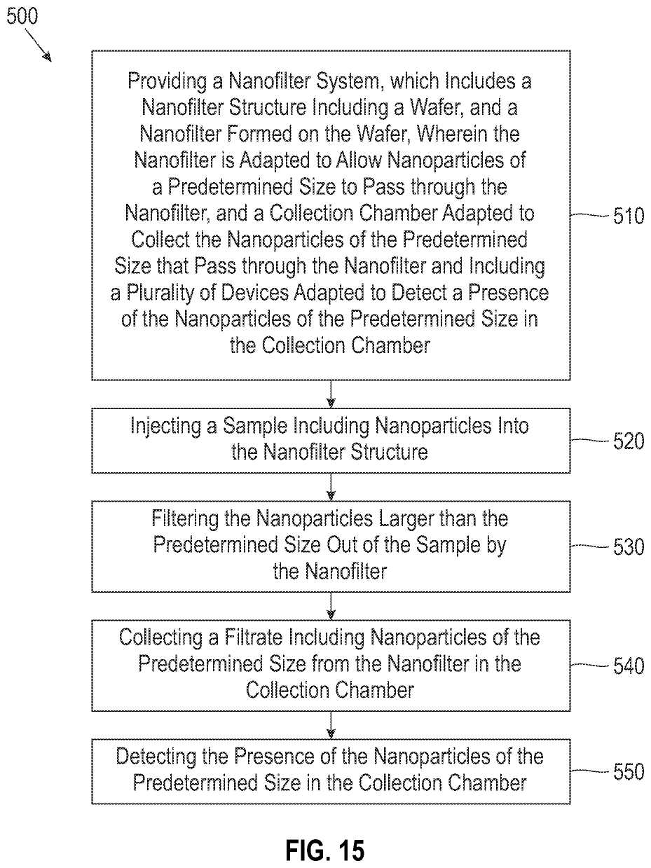

An embodiment of a disclosed process 500 for using a nanofilter system is shown FIG. 15. An operation 510 of the process 500 can be providing the nanofilter system, which includes a nanofilter structure 100 including a wafer 104, and a nanofilter portion 102 formed on the wafer 104, wherein the nanofilter portion 102 is adapted to allow nanoparticles of a predetermined size to pass through the nanofilter portion 102, and a collection chamber (e.g., 206 in FIG. 12) adapted to collect the nanoparticles of the predetermined size that pass through the nanofilter portion 102 and including a plurality of devices (e.g., 208 in FIG. 12) adapted to detect a presence of the nanoparticles of the predetermined size in the collection chamber 206. Another operation 520 can be injecting a sample including nanoparticles into the nanofilter structure 100. A further operation 530 can be filtering the nanoparticles larger than the predetermined size out of the sample by the nanofilter portion 102. Yet another operation 540 can be collecting a filtrate including nanoparticles of the predetermined size from the nanofilter portion 102 in the collection chamber 206. An additional operation 550 can be detecting the presence of the nanoparticles of the predetermined size in the collection chamber 206. The detecting operation 550 can be performed by a plurality of sensors 208. The process 500 can also include an operation of diagnosing a medical condition based on the detecting of the nanoparticles of the predetermined size in the collection chamber 206.

For purposes of description herein, the terms “upper,” “lower,” “top,” “bottom,” “left,” “right,” “rear,” “front,” “vertical,” “horizontal,” “frontside,” “backside,” and derivatives thereof shall relate to the devices as oriented in the figures. However, it is to be understood that the devices can assume various alternative orientations and step sequences, except where expressly specified to the contrary. It is also to be understood that the specific devices and processes illustrated in the attached drawings, and described in the following disclosure, are simply exemplary embodiments of the inventive concepts defined in the appended claims. Hence, other physical characteristics relating to the embodiments disclosed herein are not to be considered as limiting, unless the claims expressly state otherwise.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone or in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged and/or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

As used in this application and in the claims, the singular forms “a,”“an,” and “the” include the plural forms unless the context clearly dictates otherwise. Additionally, the term “includes” means “comprises.”

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A structure comprising:
a substrate; and
a nanofilter formed on the substrate, wherein the nanofilter is adapted to allow nanoparticles of a predetermined size to pass through the nanofilter.

2. The structure of claim 1, wherein the nanofilter includes a plurality of channels through which a sample to be filtered can flow.

3. The structure of claim 2, wherein the plurality of channels each include a plurality of grates adapted to filter the sample.

4. The structure of claim 1, wherein the nanofilter can include nanoscale grating for filtering out nanoparticles larger than openings through the nanoscale grating.

5. The structure of claim 4, wherein a size of the openings in the nanofilter grating is determined through conformal film deposition.

6. The structure of claim 1, wherein the nanofilter is coated with a biocompatible material.

7. The structure of claim 1, wherein the nanofilter is customizable based on a desired application in order to filter the nanoparticles having a particle size lower than 100 nanometers (nm).

8. A system comprising:
a nanofilter structure including
a substrate, and
a nanofilter formed on the substrate, wherein the nanofilter is adapted to allow nanoparticles of a predetermined size to pass through the nanofilter, and
a collection chamber adapted to collect the nanoparticles of the predetermined size that pass through the nanofilter and including a plurality of devices adapted to detect a presence of the nanoparticles in the collection chamber.

9. The system of claim 8, wherein the nanofilter can include nanoscale grating for filtering out nanoparticles larger than openings through the nanoscale grating.

10. The system of claim 9, wherein a size of the openings in the nanofilter grating is determined through conformal film deposition.

11. The system of claim 8, wherein the plurality of devices are transistor-based devices.

12. The system of claim 8, wherein the plurality of devices are sensors.

13. The system of claim 8, wherein the plurality of devices are adapted to detect the nanoparticles by their electric signature.

14. The system of claim 8, further comprising:
at least one additional nanofilter formed on the substrate; and
at least one additional collection chamber adapted to each collect the nanoparticles that pass through each of the at least one additional nanofilter.

15. A method of using a nanofilter system, the method comprising:
providing the nanofilter system, which includes
a nanofilter structure including
a substrate, and
a nanofilter formed on the substrate, wherein the nanofilter is adapted to allow nanoparticles of a predetermined size to pass through the nanofilter, and
a collection chamber adapted to collect the nanoparticles of the predetermined size that pass through the nanofilter and including a plurality of devices adapted to detect a presence of the nanoparticles of the predetermined size in the collection chamber;
injecting a sample including the nanoparticles into the nanofilter structure;
filtering the nanoparticles larger than the predetermined size out of the sample by the nanofilter;
collecting a filtrate including the nanoparticles of the predetermined size from the nanofilter in the collection chamber; and
detecting the presence of the nanoparticles of the predetermined size in the collection chamber.

16. The method of claim 15, wherein the detecting is performed by a plurality of sensors.

17. The method of claim 15, further comprising:
diagnosing a medical condition based on the detecting of the nanoparticles of the predetermined size in the collection chamber.

18. A method of making a nanofilter structure, the method comprising:
providing a substrate;
depositing a stack of alternating oxide layers and nitride layers on the substrate, wherein the nitride layers have a predetermined thickness;
etching the stack to form slices of the stack of the oxide layers and the nitride layers;
depositing an amorphous silicon layer on top of and surrounding the slices;
etching the amorphous silicon layer to form walls between and surrounding the slices; and
selectively etching away the nitride layers from the slices.

19. The method of claim 18, wherein the etching away of the nitride layers results in openings in the nanofilter of a predetermined size that allow a predetermined size of nanoparticle to move through the openings in the nanofilter.

20. The method of claim 18, further comprising:
depositing a biocompatible material layer between the substrate and the stack.
